(19) United States
(12) Patent Application Publication
(10) Pub. No.: US 2009/0055439 A1
(43) Pub. Date: Feb. 26, 2009

(54) Flexible Dimension Approach In A Data Warehouse

(75) Inventors: Anitha Pai, Bangalore (IN); Arunkumar Sreedharan, Bangalore (IN)

Correspondence Address: Ashok Tankha, 36 Greenleigh Drive, Sewell, NJ, 08080, US

(73) Assignee: Ketera Technologies, Inc.

(21) Appl. No.: 12/029,581

(22) Filed: Feb. 12, 2008

(30) Foreign Application Priority Data
Aug. 24, 2007 (IN) 1918/CHE/2007

(51) Int. Cl. G06F 17/30

(52) U.S. Cl. 707/200; 707/E17.001

(57) ABSTRACT

Disclosed herein is a computer implemented method for dynamically adding dimensions specific to a tenant in a data warehouse without changing the structure of the fact table. Metadata is provided in a metadata table of a warehouse staging layer to map natural key values of the dimensions, obtained from predefined placeholder columns of a source transaction table, to predefined master tables. In the warehouse staging layer, a distinct combination of the natural key values obtained from the source transaction table is assigned a surrogate key. The surrogate key is updated in the bridge table of the warehousing layer. A fact table is then populated with the assigned surrogate key of the bridge table. Views are dynamically created for the dimension tables of the dimensions to connect the fact table to the dimension tables via the bridge table.

### BACKGROUND

This invention relates, in general, to processing data in a data warehousing environment. More particularly, this invention relates to dynamically adding dimensions specific to a tenant in a data warehouse.

Most often, business organizations require certain fact data in order to make valuable business decisions. Based on these business decisions, business strategies can be established and implemented. In a data warehousing environment, analytical applications are designed with the intention of guiding tenants beyond simple operational reporting and enabling them to take immediate informed decisions. A multi-tenant pre-packaged analytical application usually comprises a single data warehouse, which caters to a standard set of facts and dimensions common across various tenants.

Problems arise when a tenant needs to analyze the fact data on a dimension, specific to the tenant's business domain. This dimension may not be part of the pre-packaged standard set of dimensions. In order to enable the addition of a new dimension to an existing standard star schema, the structure of a fact table in a data warehouse would require modification. A standard star schema is an example of a multi-dimensional data warehouse model. The star schema comprises two types of tables, namely, fact tables and dimension tables. The schema is known as a star schema because the entity-relationship between the fact table and the dimension tables resembles a star wherein one fact table is associated with multiple dimensions. A fact table typically comprises two types of columns, namely, fact columns and dimension columns. The fact columns contain the fact data, and the dimension columns contain foreign keys to the dimension tables. The level of fact data available in the fact table is known as the grain of the fact table.

Apart from the changes required in the fact table for the addition of a new dimension, the extract, transform, and load (ETL) routines required to load the fact table may also require modifications. Index and partition non-corruption need to be ensured while modifying the ETL routines. Furthermore, while modifications are being made to the fact table for a particular tenant, other tenants of the data warehouse should remain unaffected by the modifications and hence be able to use the analytical application.

An existing standard solution to the above mentioned problems involves addition of a foreign key to the fact table. This foreign key refers to the new dimension to be added. This approach results in many complexities. Firstly, the structure of the fact table requires a change due to the addition of a foreign key for each of the dimensions. The tenants may therefore be unable to use the analytical application, while the changes are being made to the fact table. Moreover, a change in the fact table requires changes in the metadata layer of the online analytical processing (OLAP) tool. Furthermore, the operation of changing the structure of the fact table based on the need for additional dimensions may prove to be a costly operation because the addition of dimensions may require partitioning and compression of the fact tables for performance requirements.

Hence, there is a need for a computer implemented method to maintain the structure of the fact table intact while adding dimensions to the data warehouse for efficient business analysis.

### SUMMARY OF THE INVENTION

Disclosed herein is a computer implemented method for maintaining the structure of the fact table intact in a data warehouse for efficient business analysis. The above stated need is addressed by dynamically adding dimensions specific to a tenant in a data warehouse, thereby ensuring that the structure of the fact table remains unchanged.

The master tables for the dimensions to be added are identified and loaded with master data of the dimensions in the source layer. The dimensions to be added for a specific tenant are referred to as nonstandard dimensions. A source transaction table of the source layer comprises placeholder columns according to the number of nonstandard dimensions to be added. These placeholder columns accommodate the natural key values of the nonstandard dimensions. The computer implemented method disclosed herein provides metadata in a metadata table of a warehouse staging layer to map natural key values of the nonstandard dimensions in the source transaction table to the newly added master tables of the source layer.

Temporary tables are created in the warehouse staging layer to assign a surrogate key to each of a distinct combination of the natural key values of the nonstandard dimensions. The combination of the natural key values of the nonstandard dimensions is obtained from the source transaction table. The assigned surrogate key is then updated in the bridge table of the warehousing layer. Dimension tables for the nonstandard dimensions, derived from the master tables of the source layer are provided in the warehousing layer. The fact table of the warehousing layer is then populated with transaction data, surrogate keys of the pre-existing standard dimensions, and the assigned surrogate key of the nonstandard dimensions from the bridge table. Views are dynamically created for the dimension tables of the nonstandard dimensions in the warehousing layer to connect the fact table with the dimension tables via the bridge table.

The computer implemented method disclosed herein maintains the structure of the fact table intact by dynamically adding nonstandard dimensions in a single column of the fact table. This method of dynamically adding nonstandard dimensions to an existing schema renders the fact table available to all the tenants while the modification is being made. If a tenant does not require a specific nonstandard dimension, the surrogate key of the fact table points to a standard record with a predefined status. The method also provides cost benefits since the structure of the fact table remains unchanged, thereby ensuring the compression and partitioning of the fact table is unaffected.

The computer implemented method disclosed herein also provides dynamic extract, transform and load routines to load the fact table and the dimension tables of the nonstandard dimensions, thereby causing no impact on the extract, transform and load scripts of the data warehousing system. The disclosed method also provides dynamic creation of views in the data warehouse, thereby ensuring a minimum effect on the online analytical processing tool (OLAP) querying the data warehouse. The computer implemented method disclosed herein may be used in a single tenant scenario as well as a multi-tenant scenario.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. The constructions below illustrate the invention in a single tenant scenario. The invention may also be used in a multi-tenant scenario, wherein a tenant key is added to all the relevant tables. However, the invention is not limited to the specific methods and instrumentalities disclosed herein.

FIG. 1 illustrates a method of dynamically adding dimensions specific to a tenant in a data warehouse.

FIG. 2 exemplarily illustrates a star schema of a data warehouse.

FIGS. 3A-3B exemplarily illustrate the structure of master tables of the nonstandard dimensions in the source layer.

FIG. 4 exemplarily illustrates the structure of a source transaction table with placeholder columns for the natural key values of the nonstandard dimensions in the source layer.

FIG. 5 exemplarily illustrates the structure of a metadata table in the warehouse staging layer.

FIG. 6 exemplarily illustrates the structure of a bridge table in the warehousing layer.

FIG. 7 exemplarily illustrates the structure of a fact table in the warehousing layer.

FIG. 8 illustrates the mapping of a surrogate key in the bridge table with the surrogate key of the fact table in the warehousing layer.

FIGS. 9A-9B exemplarily illustrate the structure of views created in the warehousing layer to connect the fact table to the dimension tables via the bridge table.

FIGS. 10A-10B exemplarily illustrate structured query language scripts for the creation of the views for the dimension tables of the nonstandard dimensions in the warehousing layer.

FIGS. 11A-11B exemplarily illustrate the relationship between fact table, the dimension table of a nonstandard dimension, the bridge table and the view created for the dimension table in the warehousing layer.

FIGS. 12A-12L illustrate an example of dynamically adding dimensions specific to a tenant in a data warehouse.

### DETAILED DESCRIPTION OF THE DRAWINGS

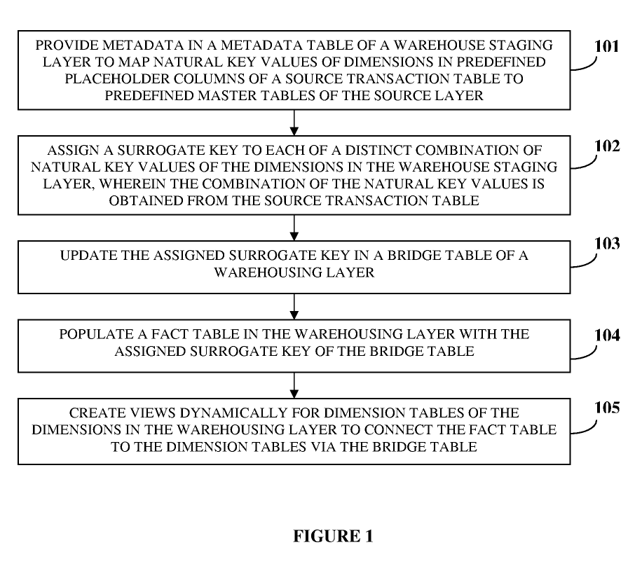

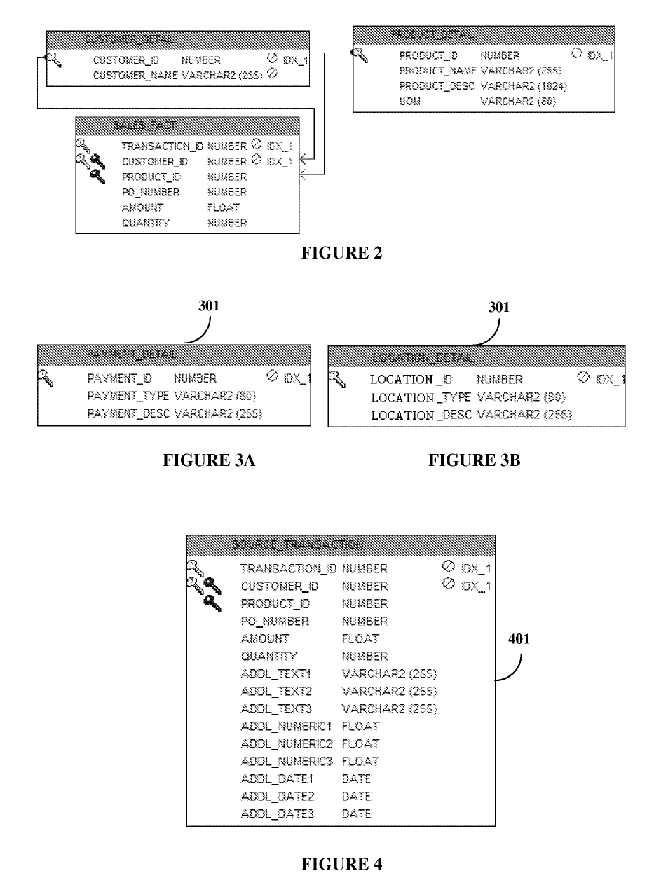

FIG. 1 illustrates a method of dynamically adding dimensions specific to a tenant in a data warehouse. In an analytical data warehousing application, transport operations extract data from the source layer of the data warehousing system, transform the data in a warehouse staging layer and load the transformed data into the warehousing layer. The warehousing layer comprises the data warehouses into which transformed data is loaded. A single data warehouse comprises a standard set of facts and dimensions common across various tenants. FIG. 2 exemplarily illustrates a star schema of a data warehouse. The schema illustrated in FIG. 2 comprises a fact table and dimension tables of the standard dimensions. When a tenant wants to analyze fact data on a dimension specific to a business domain, dimensions may need to be added into the fact table. The dimensions required by a tenant are referred to as nonstandard dimensions. The nonstandard dimensions may be one of a hierarchical and a non hierarchical nature. The dynamic addition of nonstandard dimensions specific to a tenant in the data warehouse without changing the structure of the fact table is illustrated in FIG. 1.

Master tables 301 for the nonstandard dimensions are firstly identified. The structure of the master tables 301 of the nonstandard dimensions is exemplarily illustrated in FIGS. 3A-3B. The master tables 301 comprise master data for the nonstandard dimensions. The structure and naming convention of the master data in the master tables 301 follow a set of standard guidelines to ensure dynamic extraction, transformation, and loading of the dimension tables and the fact table 701 in the data warehouse. A source transaction table 401 of the source layer comprises placeholder columns according to the number of nonstandard dimensions to be added as illustrated in FIG. 4. The source transaction table 401 comprises transaction data of the business organization. The number of placeholder columns in the source transaction table 401 for a given tenant may vary depending on the number of nonstandard dimensions required by the tenants. The placeholder columns of the source transaction table 401 accommodate the natural key values of the nonstandard dimensions.

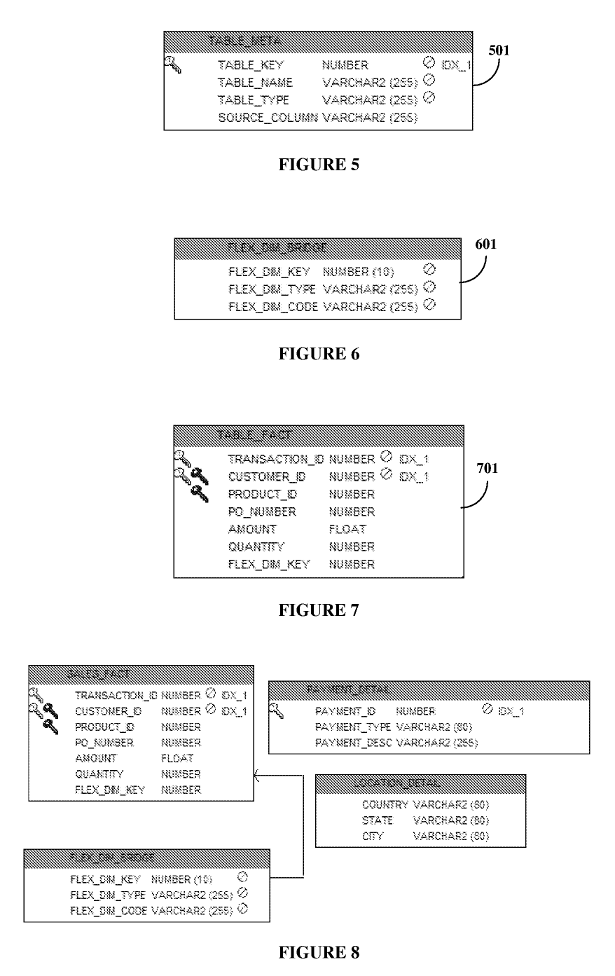

In the warehouse staging layer of the data warehousing application, metadata is provided 101 in a metadata table 501 to map the natural key values of the nonstandard dimensions in the placeholder columns of the source transaction table 401 to the master tables 301 of the source layer. The structure of the metadata table 501 of the warehouse staging layer is exemplarily illustrated in FIG. 5. The metadata table 501 comprises columns for the table name, the table type, and source column for the master tables 301. The source column, namely, SOURCE_COLUMN of the metadata table 501 comprises the names of the placeholder columns added in the source transaction table 401. The master tables 301 for the nonstandard dimensions are identified as ‘nonstandard’ in the single column, namely TABLE_TYPE, of the metadata table 501, and ‘standard’ for the pre-existing standard dimensions.

The metadata table 501 in the warehouse staging layer identifies the placeholder columns of the source transaction table 401, and the ETL routines extract the natural key values from the identified placeholder columns. The ETL routines then populate these natural key values along with the associated master table names into a first temporary staging table. The ETL routines also create a second temporary staging table comprising the distinct combination of the natural key values of the nonstandard dimensions obtained from the source transaction table 401. The second temporary staging table comprises an additional column to accommodate a surrogate key. The surrogate key is assigned 102 to each of the distinct combination of the natural key values of the nonstandard dimensions. The distinct records in the second temporary staging table are transposed by the ETL routines in the warehouse staging layer in order to populate the bridge table 601 of the warehousing layer. The structure of the bridge table 601 of the warehousing layer is exemplarily illustrated in FIG. 6.

In the warehousing layer of the data warehousing application, the bridge table 601 is populated with data from the second temporary staging table after transposing the contents of the second temporary staging table. Therefore, the bridge table 601 is updated 103 with the surrogate key assigned in the warehouse staging layer. The bridge table 601 of the warehousing layer comprises columns for dimension type and dimension code. The dimension type column of the bridge table 601 indicates the master tables 301 for the assigned surrogate key, and the dimension code column holds the natural key values of the nonstandard dimensions. Dimension tables are then provided in the warehousing layer for the nonstandard dimensions. The dimension tables are loaded with master data from the corresponding master tables 301 of the source layer by the ETL routines. Subsequently, the fact table 701 of the data warehouse is populated 104 with transaction data of the source transaction table 401, surrogate keys of the pre-existing standard dimensions, and the assigned surrogate key of the bridge table 601. The structure of the fact table 701 in the warehousing layer is exemplarily illustrated in FIG. 7. A single column, namely FLEX_DIM_KEY in the fact table 701 holds the surrogate key, thereby mapping the surrogate key of the fact table 701 to the surrogate key of the bridge table 601. This mapping of a surrogate key in the bridge table 601 with the surrogate key of the fact table 701 in the warehousing layer is illustrated in FIG. 8. If a tenant does not require a specific nonstandard dimension, the surrogate key of the fact table 701 points to a standard record with a predefined status, thereby rendering the fact table 701 available to a plurality of tenants.

The assigned surrogate key for a combination of natural key values obtained from the source transaction table 401 ensures that one record of a fact table 701 of the data warehouse points to more than one nonstandard dimension. When more nonstandard dimensions need to be added to the schema, the bridge table 601 gets reloaded, thereby generating a surrogate key for each of a distinct combination of the natural key values of the nonstandard dimensions obtained from the source transaction table 401. Therefore, the schema is capable of handling any number of nonstandard dimensions without changing the structure of the fact table 701.

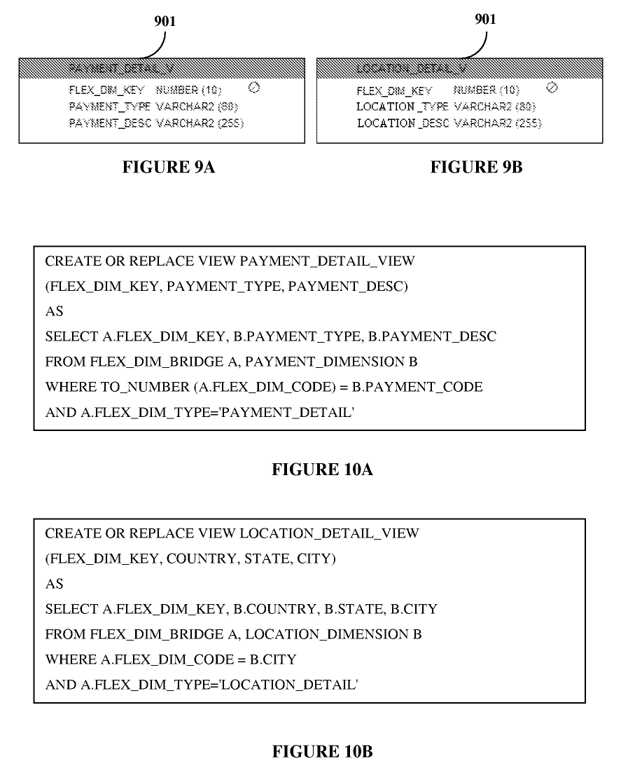

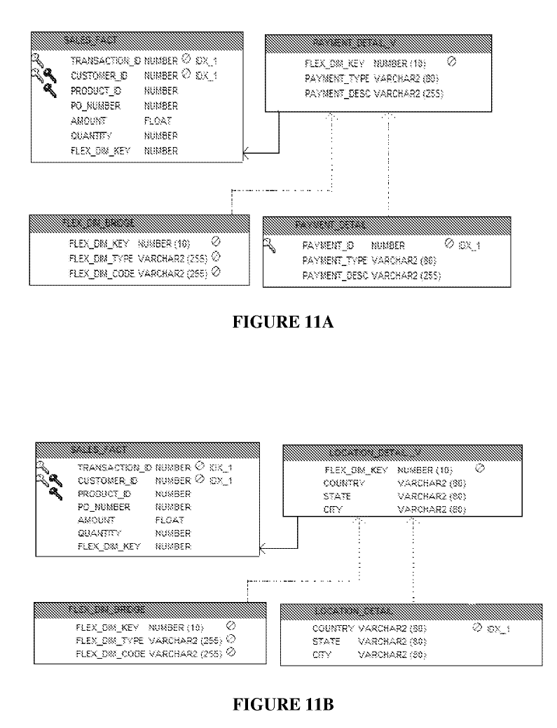

In addition, views 901 are dynamically created 105 for the dimension tables of the nonstandard dimensions to connect the fact table 701 to the dimension tables via the bridge table 601. The views 901 created in the warehousing layer are exemplarily illustrated in FIGS. 9A-9B. Views 901 for the dimension tables of the nonstandard dimensions may be created using structured query language (SQL). SQL is designed for retrieving data from a data warehouse. The SQL scripts for the creation of views 901 for the dimension tables of the nonstandard dimensions are exemplarily illustrated in FIGS. 10A-10B. An online analytical processing (OLAP) tool may now query the data warehouse using the views 901 created using the SQL scripts. The OLAP tool enables multidimensional viewing, querying, and analysis of a business' operational data. The OLAP tool may be used in business areas such as sales, marketing etc. Quick responses to complex analytical queries on particular dimensions in the data warehouse are obtained using the OLAP tool. The dynamic creation of views 901 in the warehousing layer ensures a minimum effect on the OLAP tool querying the data warehouse. The relationship between fact table 701, a dimension table of a nonstandard dimension, the bridge table 601 and the view created for the dimension table in the warehousing layer is illustrated in FIGS. 11A-11B.

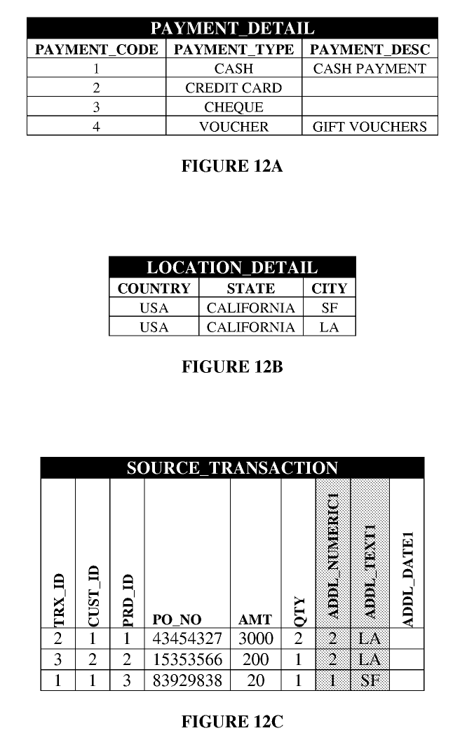

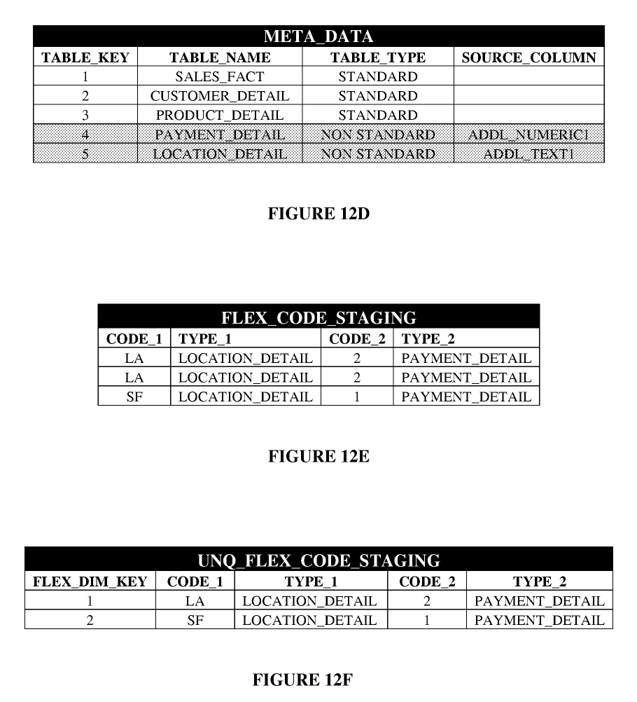

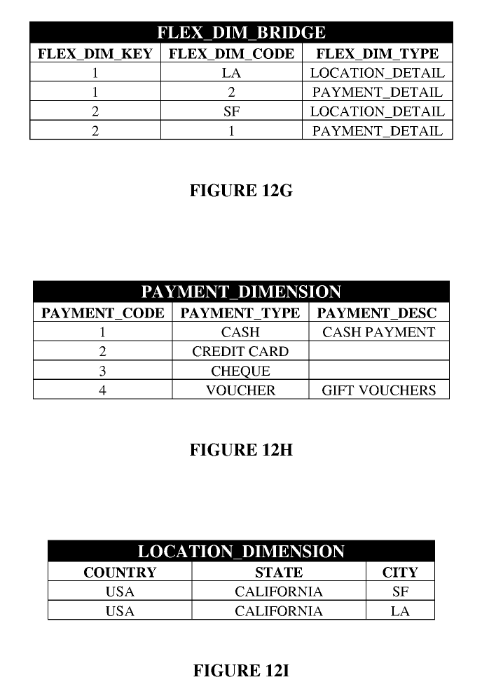

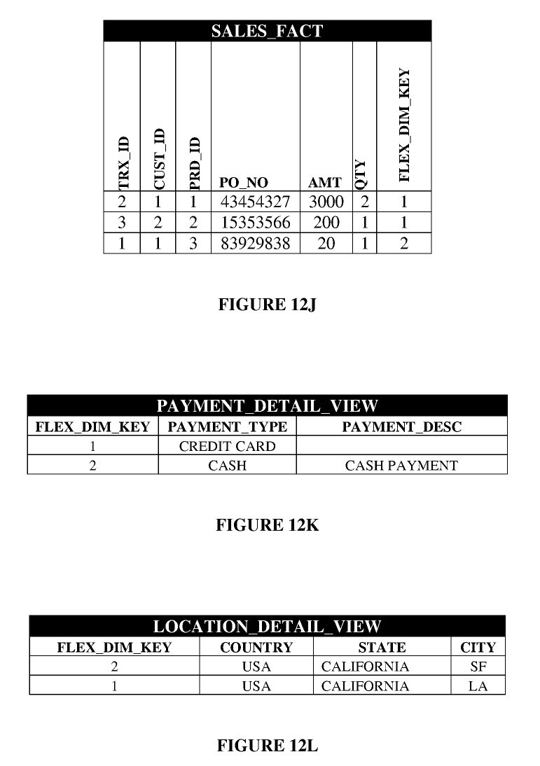

FIGS. 12A-12L illustrates an example of dynamically adding dimensions specific to a tenant in a data warehouse. The example illustrates the addition of two nonstandard dimensions into the star schema illustrated in FIG. 2 without changing the structure of the fact table 701. Consider the analysis of sales data in a department store warehouse. The star schema comprises a fact table 701 and two dimension tables for the ‘customer’ and ‘product’ dimensions. When one of the tenants of the application expresses a need to analyze sales based on two nonstandard dimensions, for example, payment and location details, a ‘payment’ dimension and a ‘location’ dimension need to be added to the fact table 701. This requires two new master tables 301 for the nonstandard dimensions to be identified and loaded with master data. FIGS. 12A-12B illustrate the master tables 301 for the ‘payment’ dimension and ‘location’ dimension respectively. The master tables 301 are identified as the PAYMENT_DETAIL table and the LOCATION_DETAIL table in the source layer of the data warehousing application. The SOURCE_TRANSACTION table illustrated in FIG. 12C comprises two placeholder columns, namely, ADDL_NUMERIC1 and ADDL_TEXT1, for the payment dimension and location dimension respectively. The placeholder columns accommodate the natural key values of the PAYMENT_DETAIL table and the LOCATION_DETAIL table.

A metadata table is provided in the warehouse staging layer to map the natural key values of the payment dimension and location dimension in the placeholder columns of the SOURCE_TRANSACTION table to the associated master tables 301. The META_DATA table is inserted with columns, namely, TABLE_NAME, TABLE_TYPE, and SOURCE_COLUMN as illustrated in FIG. 12D. The TABLE_NAME column comprises the names of all the master tables 301 in the star schema. The TABLE_TYPE column comprises the type of the dimensions, namely ‘standard’ and ‘nonstandard’. The table type distinguishes the preexisting standard dimensions from the nonstandard dimensions. As illustrated in FIG. 12D, SALES_FACT, CUSTOMER_DETAIL, AND PRODUCT_DETAIL tables are identified as ‘standard’, whereas the master tables 301 for the nonstandard dimensions, namely, PAYMENT_DETAIL and LOCATION_DETAIL tables are identified as ‘non standard’ in the META_DATA table. The SOURCE_COLUMN provides the names of the placeholder columns from the SOURCE_TRANSACTION table.

Based on the records in the META_DATA table, the ETL routines create a first temporary staging table, namely, FLEX_CODE_STAGING table, as illustrated in FIG. 12E, in the warehouse staging layer of the data warehousing application. The ETL routines populate the natural key values from the placeholder columns identified by the META_DATA table into the FLEX_CODE_STAGING table along with the master table names of the nonstandard dimensions. The first temporary staging table is created with a dynamic length depending on the number of nonstandard dimensions to be added. A second temporary staging table, namely, UNQ_FLEX_CODE_STAGING table is then created comprising a distinct combination of the natural key values from the FLEX_CODE_STAGING table, as illustrated in FIG. 12F. A surrogate key is then assigned to each of the distinct combination of the natural key values in a FLEX_DIM_KEY column of the UNQ_FLEX_CODE_STAGING table. As illustrated in FIG. 12F, a surrogate key of ‘1’ is assigned to the distinct combination of the natural key values ‘LA’ and ‘2’. Similarly, a surrogate key of ‘2’ is assigned to the distinct combination of the natural key values ‘SF’ and ‘1’. The ETL routines then transpose the distinct records of the UNQ_FLEX_CODE_STAGING table in order to populate the bridge table 601, namely, the FLEX_DIM_BRIDGE table of the warehousing layer.

The FLEX_DIM_BRIDGE table, as illustrated in FIG. 12G, comprises the assigned surrogate key for the distinct combination of the natural key values of the ‘location’ dimension and the ‘payment’ dimension in the FLEX_DIM_KEY column of the FLEX_DIM_BRIDGE table. As illustrated in FIGS. 12H-12I, dimension tables for the nonstandard dimensions, namely PAYMENT_DIMENSION table and LOCATION_DIMENSION table are created in the warehousing layer. The dimension tables are derived from the master tables 301 of the source layer. The SALES_FACT table of the data warehouse is then populated with transaction data provided in the SOURCE_TRANSACTION table and the FLEX_DIM_KEY of the FLEX_DIM_BRIDGE table by the ETL routines. The FLEX_DIM_KEY column in the SALES_FACT table holds the surrogate key of the distinct combination of the natural key values of the nonstandard dimensions, thereby mapping the FLEX_DIM_KEY column in the SALES_FACT table to the FLEX_DIM_KEY column of the FLEX_DIM_BRIDGE table. FIG. 12J illustrates the SALES_FACT table comprising the surrogate key for the ‘location’ dimension and ‘payment’ dimension.

Views 901 are then dynamically created for the dimension tables of the nonstandard dimensions to connect the SALES_FACT table to the PAYMENT_DIMENSION table and LOCATION_DIMENSION table via the FLEX_DIM_BRIDGE table. These views 901, namely PAYMENT_DETAIL_VIEW and LOCATION_DETAIL_VIEW may be created using the SQL scripts illustrated in FIGS. 10A-10B respectively.

The views 901 created will be used by the OLAP tool to refer to the PAYMENT_DIMENSION table and LOCATION_DIMENSION table of the data warehouse. The OLAP tool is used by a tenant to query the data warehouse for the nonstandard dimensions required for sales analysis of the department store. The data warehousing application may be used in single tenant and multiple tenant scenarios.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described, such as the databases of a data warehouse, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors that are adapted to communicate with the computer. Any number and type of machines may be in communication with the computer.

The foregoing examples have been provided merely for the purpose of explanation and are in no way to be construed as limiting of the present method disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of dynamically adding dimensions specific to a tenant in a data warehouse, comprising the steps of:
providing metadata in a metadata table of a warehouse staging layer to map natural key values of said dimensions in predefined placeholder columns of a source transaction table of a source layer, to predefined master tables of said source layer;
assigning a surrogate key to each of a distinct combination of said natural key values of the dimensions in said warehouse staging layer, wherein said combination of the natural key values is obtained from said source transaction table;
updating said assigned surrogate key in a bridge table of a warehousing layer;
populating a fact table in said warehousing layer with the assigned surrogate key of said bridge table; and
creating views dynamically for dimension tables of the dimensions in the warehousing layer to connect said fact table to said dimension tables via the bridge table;
whereby dynamically adding the dimensions maintains the structure of the fact table, and provides the dimensions specific to said tenant in said data warehouse.

2. The computer implemented method of claim 1, wherein the dimensions are one of a hierarchical nature and non hierarchical nature.

3. The computer implemented method of claim 1, wherein each of the dimensions has a one to one relationship with the fact table.

4. The computer implemented method of claim 1, wherein the tenant is one of a single tenant and a plurality of tenants.

5. The computer implemented method of claim 1, wherein said placeholder columns of the source transaction table are predefined based on the number of dimensions.

6. The computer implemented method of claim 1, wherein structure and naming convention of master data in said predefined master tables follows a set of standard guidelines to ensure dynamic extraction, transformation, and loading of the dimension tables and the fact table.

7. The computer implemented method of claim 1, wherein said metadata table comprises a single column with a nonstandard value for identifying said predefined master tables of the dimensions.

8. The computer implemented method of claim 1, wherein a first temporary staging table is created in the warehouse staging layer comprising the combination of the natural key values of the dimensions.

9. The computer implemented method of claim 8, wherein said first temporary staging table is created with dynamic length depending on the number of dimensions.

10. The computer implemented method of claim 1, wherein a second temporary staging table is created in the warehouse staging layer comprising said distinct combination of the natural key values of the dimensions.

11. The computer implemented method of claim 10, wherein the surrogate key for the distinct combination of the natural key values of the dimensions is assigned in said second temporary staging table.

12. The computer implemented method of claim 11, wherein records of the second temporary staging table are transposed to update the assigned surrogate key in the bridge table of the warehousing layer.

13. The computer implemented method of claim 1, wherein the bridge table comprises dimension type column, and a dimension code column.

14. The computer implemented method of claim 13, wherein said dimension type column indicates said predefined master tables for the assigned surrogate key, and said dimension code column holds the natural key values of the dimensions.

15. The computer implemented method of claim 1, wherein the dimension tables in the warehousing layer are derived from each of said predefined master tables of the source layer.

16. The computer implemented method of claim 1, wherein the surrogate key in the fact table points to a standard record with a predefined status for tenants not requiring specific dimensions.

17. The computer implemented method of claim 1, wherein said views for the dimension tables of the dimensions, are created using structured query language.

18. A computer program product comprising computer executable instructions embodied in a computer-readable medium, wherein said computer program product comprises:
a first computer parsable program code for providing metadata in a metadata table of a warehouse staging layer to map natural key values of dimensions in predefined placeholder columns of a source transaction table of a source layer, to predefined master tables of said source layer;
a second computer parsable program code for assigning a surrogate key to each of a distinct combination of said natural key values of said dimensions in said warehouse staging layer, wherein said combination of the natural key values is obtained from said source transaction table;
a third computer parsable program code for updating said assigned surrogate key in a bridge table of a warehousing layer;
a fourth computer parsable program code for populating a fact table in said warehousing layer with the assigned surrogate key of said bridge table; and
a fifth computer parsable program code for creating views dynamically for dimension tables of the dimensions in the warehousing layer to connect said fact table to said dimension tables via the bridge table.

19. The computer program product of claim 18, further comprising a sixth computer parsable program code for ensuring dynamic extraction, transformation, and loading of data in said predefined master tables, the dimension tables and the fact table.

20. The computer program product of claim 18, further comprising a seventh computer parsable program code for predefining said placeholder columns in the source transaction table based on the number of dimensions.

21. The computer program product of claim 18, further comprising an eighth computer parsable program code for identifying said predefined master tables of the dimensions by using nonstandard values of said metadata table.

22. The computer program product of claim 18, further comprising a ninth computer parsable program code for pointing the surrogate key of the fact table to a standard record with a predefined status for tenants not requiring specific dimensions.
